(19) United States
(12) Patent Application Publication
(10) Pub. No.: US 2025/0355905 A1
(43) Pub. Date: Nov. 20, 2025

(54) RECURSIVE MULTI-METRIC EXPANSION FOR QUERIES

(71) Applicant: Salesforce, Inc., San Francisco, CA (US)

(72) Inventors: Avi Brenner, Queen Creek, AZ (US); Vincent Tang, New York, NY (US); Ka Man Mary Wong, Vancouver (CA); Derek Wong, Vancouver (CA); Irene Fung, Vancouver (CA)

(21) Appl. No.: 18/666,244

(22) Filed: May 16, 2024

(51) Int. Cl. G06F 16/332; G06F 16/33; G06F 16/338; G06F 16/34

(52) U.S. Cl. CPC G06F 16/3329; G06F 16/3347; G06F 16/338; G06F 16/345; G06N 20/00

(57) ABSTRACT

Methods, systems, apparatuses, devices, and computer program products are described. A processing device may receive a natural language query asking a question about a data metric. The processing device may use a large language model (LLM) to generate a summary of the natural language query for vector embedding. The processing device may determine one or more query response portions indicating possible answers to the query based on the summary and a vector database including vector representations of data summaries. To expand the scope of the answers, the processing device may recursively expand a set of data metrics for analysis. For example, the processing device may determine additional data metrics adjacent to the data metric of the query and may search the vector database for additional query response portions based on the additional data metrics. The processing device may use the query response portions to answer the natural language query.

### FIELD OF TECHNOLOGY

The present disclosure relates generally to database systems and data processing, and more specifically to recursive multi-metric expansion for queries.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some CRM systems, users may ask questions about data metrics. For example, a CRM system may support natural language queries requesting information about the driving factors affecting a specific data metric. However, the CRM system may fail to expand the scope of the query to determine underlying factors that can indirectly affect the data metric. Additionally, or alternatively, searching a full set of CRM data to detect any driving factors may involve a significant processing overhead, effectively reducing the efficiency of answering user queries.

### BRIEF DESCRIPTION OF THE DRAWINGS

FIG. 1 illustrates an example of a system for cloud computing that supports recursive multi-metric expansion for queries in accordance with aspects of the present disclosure.

FIG. 2 shows an example of a system that supports recursive multi-metric expansion for queries in accordance with aspects of the present disclosure.

FIGS. 3A, 3B, 3C, and 3D show examples of processes that support recursive multi-metric expansion for queries in accordance with aspects of the present disclosure.

FIG. 4 shows an example of an offline indexing procedure that supports recursive multi-metric expansion for queries in accordance with aspects of the present disclosure.

FIG. 5 shows an example of a process flow that supports recursive multi-metric expansion for queries in accordance with aspects of the present disclosure.

FIG. 6 shows a block diagram of an apparatus that supports recursive multi-metric expansion for queries in accordance with aspects of the present disclosure.

FIG. 7 shows a block diagram of a recursive query response manager that supports recursive multi-metric expansion for queries in accordance with aspects of the present disclosure.

FIG. 8 shows a diagram of a system including a device that supports recursive multi-metric expansion for queries in accordance with aspects of the present disclosure.

FIGS. 9 and 10 show flowcharts illustrating methods that support recursive multi-metric expansion for queries in accordance with aspects of the present disclosure.

### DETAILED DESCRIPTION

A database system, such as a multi-tenant database system, may support a customer relationship management (CRM) service. For example, the database system may track data metrics for one or more tenants (e.g., organizations) of the CRM service, including CRM data, CRM operations, user activities, or any combination of these or other data metrics. In some cases, one or more data metrics stored in the database system may be the driving factor(s) in a change to another data metric. Determining the driving factors may allow an organization to mitigate an undesirable change or target a desirable change. A user of the CRM service may run analytics to detect the driving factors affecting a data metric. For example, the CRM service may include a user interface (UI) supporting user queries about data metrics. The user may input a natural language query asking a question about one of the data metrics. However, some systems may fail to expand the scope of the query to determine underlying factors that can indirectly affect the data metric. Additionally, or alternatively, searching a full set of data metrics to detect any driving factors may involve a significant processing overhead, effectively reducing the efficiency of answering the user's query.

A system may support techniques for recursive multi-metric expansion of queries to improve the query scopes while efficiently managing processing resources. For example, the system may receive a user input indicating a natural language query, where the natural language query includes a question about a data metric. The system may input, to a large language model (LLM), a generative prompt based on the natural language query. The LLM may output a summary of the natural language query for vector embedding. The system may send the summary to a vector database to determine related vectors representing query response portions embedded in a vector space. The vector database may return one or more query response portions indicating possible responses to the natural language query. To improve the scope of the query process, the system may expand the query to include a data metric set including other data metrics adjacent to the data metric asked about in the query. For example, the system may again use an LLM to determine additional summaries associated with the expanded set of data metrics. The system may use the vector database and vector embeddings for the additional summaries to determine additional query response portions. In some cases, the system may recursively expand beyond this set of data metrics to other adjacent data metrics, further improving the scope of the query response. However, the system may perform the recursion according to a recursion depth to satisfy a threshold processing overhead associated with the query answering procedure. In some cases, the system may improve a processing overhead by limiting the recursion depth. The system may generate an answer to the natural language query using the query response portions determined based on the recursively expanded set of data metrics. A UI may present the answer in response to the user's query.

In some examples, a user (e.g., an administrative user, the user inputting the natural language query) may set the recursion depth for the process. In some other examples, the system may set the recursion depth based on a default value, a processing overhead allocated for the user or organization, a processing resource availability for the query answering procedure, or some other policy or rule. Setting the recursion depth may provide guardrails for a quantity of processing resources used to complete the query answering procedure.

Additionally, or alternatively, the system may support an offline indexing procedure to create and maintain the vector database for the query answering procedure. The vector database may include vectors representing summaries of data from a CRM service (e.g., a multi-tenant database system). In some cases, the vector database may store separate vector spaces for different tenants of the multi-tenant database system to ensure data security and privacy. The system may automatically update the vector database to maintain synchronicity with the database system. For example, the system may update the vector database according to a schedule or a trigger, such that the vectors in the vector database represent up-to-date summaries of the data metrics in the database system.

Aspects of the disclosure are initially described in the context of an environment supporting an on-demand database service. Additional aspects of the disclosure are described with reference to systems and processes for recursive multi-metric expansion. Aspects of the disclosure are further illustrated by and described with reference to apparatus diagrams, system diagrams, and flowcharts that relate to recursive multi-metric expansion for queries.

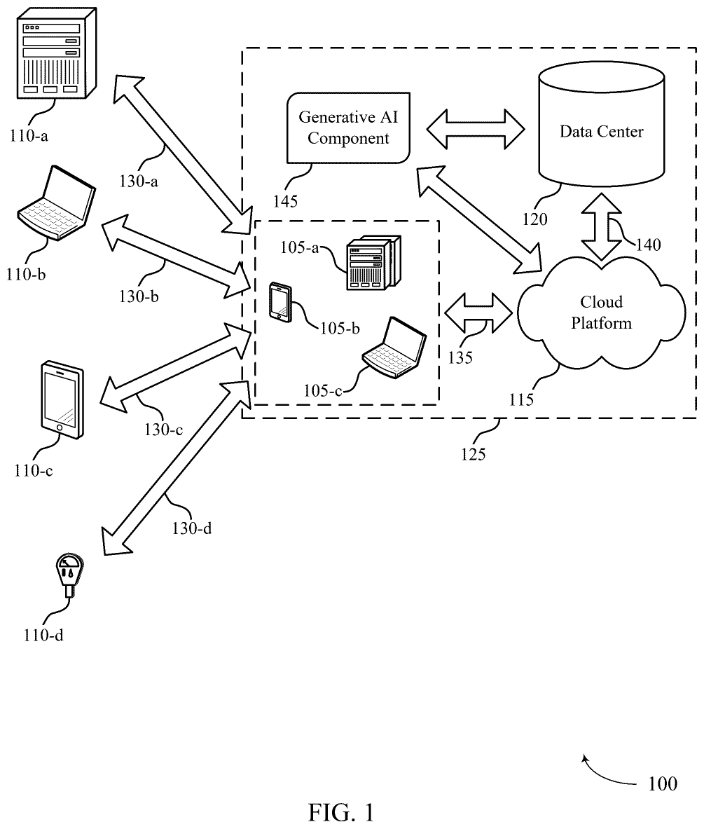

FIG. 1 illustrates an example of a system 100 for cloud computing that supports recursive multi-metric expansion for queries in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

The system 100 may support recursive multi-metric question-and-answering with semantic summaries. To support such techniques, the system 100 may include a generative artificial intelligence (AI) component 145. The generative AI component 145 may be an example or a component of an LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

The system 100 may use the generative AI component 145 to expand a set of data metrics for analysis. For example, a cloud client 105 may input a query (e.g., a natural language query) asking about a data metric. The system 100 may generate a prompt requesting to expand beyond the data metric to other adjacent, related, or underlying data metrics. The system 100 may input the prompt to the generative AI component 145 (e.g., an LLM) to obtain a response indicating other possible data metrics. The system 100 may use a vector database to resolve the response to actual data metrics stored at the data center 120. The system 100 may analyze the expanded set of data metrics (e.g., further using the generative AI component 145) to automatically improve the scope of the query.

Some other systems may determine driving factors for one or more data metrics input by a user. However, such systems may rely on the domain knowledge of the users and may fail to capture underlying or indirect driving factors. Additionally, such systems may be susceptible to human biases. In some cases, other systems may search relatively large sets of data metrics for driving factors. However, such searches may involve significant processing overheads. The processing resources used to search a database for any relevant driving factors may exceed a threshold (e.g., an available threshold, a cost-effective threshold).

In contrast, the system 100 may leverage the vectorization of data summaries to reduce the overhead associated with searching for driving factors. Additionally, the system 100 may set a threshold depth for the recursive expansion of data metrics to reduce the processing overhead associated with answering the queries. For example, the threshold depth may place guardrails on the processing and time resources for answering the queries. The automated recursive process may determine relevant data metrics and driving factors without further user input or user domain knowledge, effectively mitigating human biases in answering the queries. Additionally, or alternatively, the system 100 may support real-time (or near-real-time) attuning to user queries, data updates, and tenant parameters or policies.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

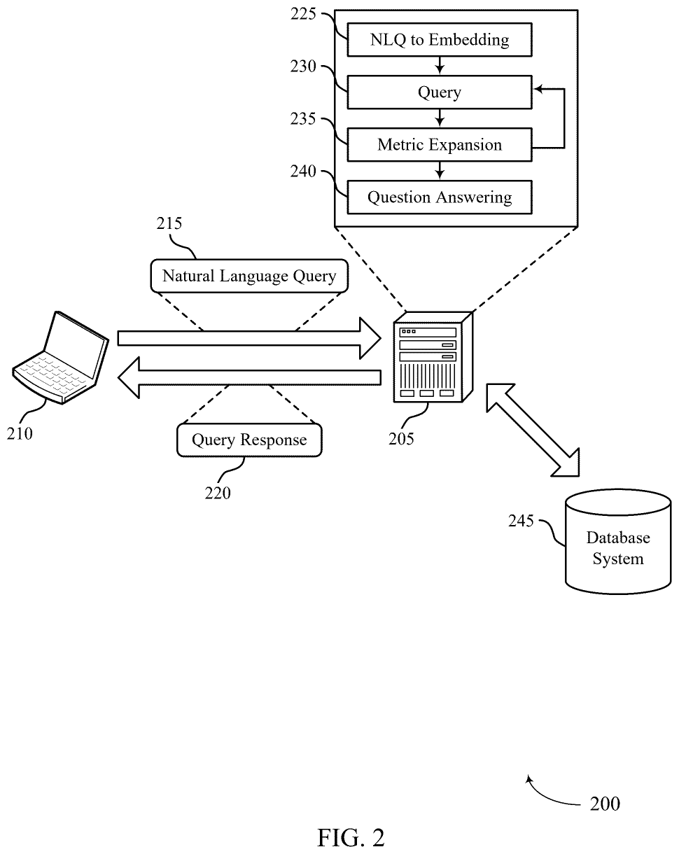

FIG. 2 shows an example of a system 200 that supports recursive multi-metric expansion for queries in accordance with aspects of the present disclosure. The system 200 may include a processing device 205, a user device 210, and a database system 245. The processing device 205 may be a component of a system 100, the user device 210 may be an example of a cloud client 105 or a contact 110, and the database system 245 may be an example of a data center 120 or a cloud platform 115, as described with reference to FIG. 1. The processing device 205 may be an example of any processing device or system, such as an application server, a database server, a cloud-based server or service, a worker server, a server cluster, a virtual machine, a container, a network device, a user device, or any combination of these or other computing devices. In some examples, the processing device 205 may be an example or a component of the user device 210 or the database system 245. The user device 210 may be an example of a smartphone, a laptop, a desktop, a smartwatch, or any other device that supports inputs and outputs for a user operating the device. The database system 245 may be an example of a CRM database storing data metrics for business operations, user activity in a CRM system, or both. The system 200 may support a user inputting a natural language query 215 to the user device 210. The user device 210 may communicate with the processing device 205 to determine a query response 220 for the natural language query 215 using one or more recursive multi-metric expansion techniques.

A user operating the user device 210 may analyze data tracked, or otherwise stored, at the database system 245. For example, the database system 245 may track one or more data metrics associated with CRM activities for one or more tenants of a multi-tenant database system. The user may input questions to determine driving factors affecting data metrics of the database system 245. For example, data metrics may change over time, and the system 200 may support investigations into such changes. The system 200 may use recursive multi-metric expansion to answer driver-style questions across multiple data metrics, including internal factors and adjacent data metric factors that may affect other metrics.

For example, the user operating the user device 210 may input a natural language query 215 via a UI. The natural language query may ask about the internal drivers (e.g., driving factors) for one or more data metrics (e.g., business metrics). The user device 210 may send the natural language query 215 to the processing device 205 for handling. The processing device 205 may use a generative AI model, such as an LLM, to handle the natural language query 215. For example, the LLM may support summarizing answers to specific questions targeted at data metrics.

Other systems may be single-metric focused or inwardly focuses. For example, such systems may search for internal driving factors but may fila to account for the effects that one metric may have on another. As an example, a query may ask “Why has our customer satisfaction score decreased?” These other systems may determine that the query corresponds to (e.g., targets) the customer satisfaction (CSAT) metric. The systems may determine an internal factor affecting the CSAT metric, such as service requests for headphones increasing by 22%. However, this answer may fail to capture the entire picture. For example, the systems may miss other important driving factors.

In contrast, the system 200 may use vector embeddings and multi-metric expansion to search for answers across full sets of data metrics (e.g., full sets of available metrics). The processing device 205 may determine relevant parts from any metric to answer the natural language query 215. The processing device 205 may search for results based on the requested data metric, but may then additionally ask to find adjacent metrics that might affect the requested data metric (e.g., using a list of indexed metrics in a vector space). The processing device 205 may recursively ask to expand the set of relevant data metrics (e.g., to a threshold depth of X levels) to improve the granularity of the response. The processing device 205 may use detailed instructions to prompt an LLM to answer the user's question based on any affecting metrics identified during the recursive process. Accordingly, the processing device 205 may perform an efficient, deep search of metrics to answer the natural language query 215 and may provide the user with clear and concise information indicating an answer. For example, the processing device 205 may output a query response 220 indicating the answer for display at the user device 210.

In the example where the natural language query 215 asks “Why has our customer satisfaction score decreased?”, the processing device 205 may search for driving factors to the CSAT score. The processing device 205 may identify that service requests for headphones has increased by 22%. However, the processing device 205 may additionally perform metric expansion and determine driving factors for the increase in service requests for headphones. For example, the processing device 205 may identify that the service requests for headphones have increased based on a time to close metric increasing by 12%. The processing device 205 may perform further metric expansion and determine that the time to close increasing by 12% may relate to a decrease in service agent availability by 17%. The processing device 205 may generate a query response 220 (e.g., a natural language query response using an LLM) indicating each of these factors, providing a relatively more thorough answer to the user's query.

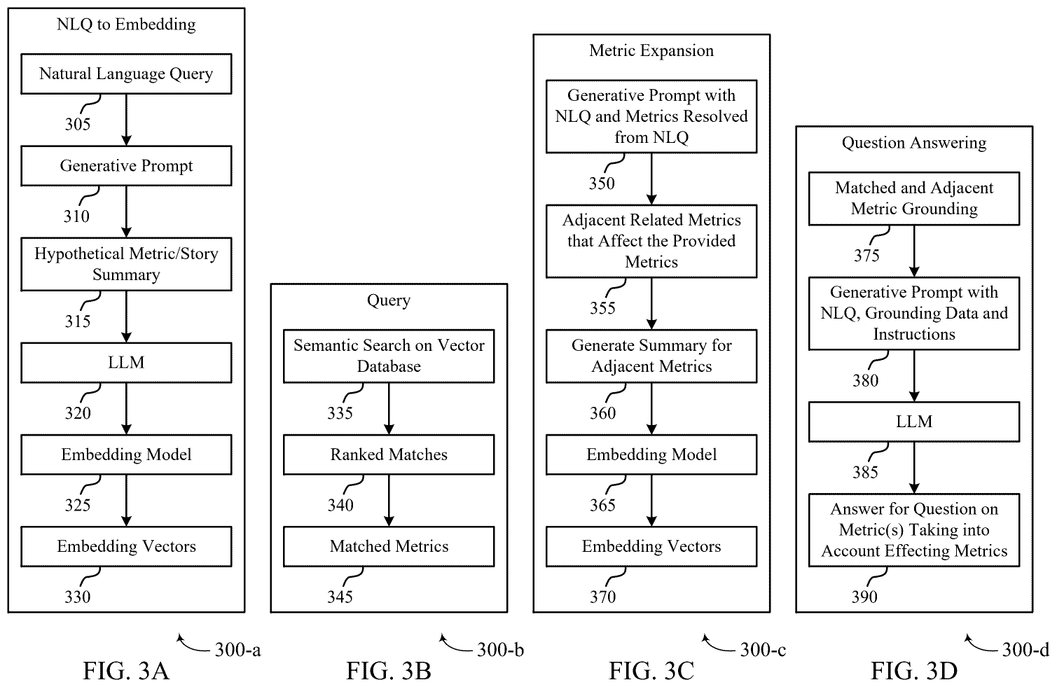

To perform the recursive multi-metric expansion for queries, the processing device 205 may perform natural language query-to-embedding transformation 225 (as described in more detail with reference to FIG. 3A), query answering 230 (as described in more detail with reference to FIG. 3B), metric expansion 235 (as described in more detail with reference to FIG. 3C), and question answering 240 (as described in more detail with reference to FIG. 3D). The processing device 205 may recursively perform metric expansion 235 and query answering 230 for the expanded set of metrics according to a threshold depth for the recursion. Accordingly, the system 200 may support repeatedly expanding adjacent metrics using an LLM to improve the accuracy and detail of the query responses.

FIGS. 3A, 3B, 3C, and 3D show examples of a processes that support recursive multi-metric expansion for queries in accordance with aspects of the present disclosure. FIG. 3A shows an example of a process 300-a that supports natural language query embedding. The process 300-a may convert a natural language query 305 to a vector embedding via a generative summary. A processing device (e.g., a single device or a system of devices), such as a processing device 205 as described with reference to FIG. 2, may perform the process 300-a. The processing device may communicate with a vector database. In some examples, the processing device or the vector database may use an embedding model 325 to determine embedding vectors 330 based on LLM outputs.

The processing device may receive the natural language query 305 from a user device, such as a user device 210 as described with reference to FIG. 2. The processing device may create a generative prompt 310 based on the natural language query 305. For example, the generative prompt 310 may include the natural language query 305 or a portion of the natural language query 305. In some cases, the processing device may clean the natural language query 305 to remove one or more characters, one or more words or phrases, or some combination thereof to improve the format of the query for the generative prompt 310. Additionally, the processing device may generate a hypothetical summary 315 of the type of story information (e.g., a data story) that could answer the natural language query 305. The hypothetical summary 315 may provide a format for answering the natural language query 305. The processing device may input the generative prompt 310, the hypothetical summary 315, or both to an LLM 320. The LLM 320 may be an off-the-shelf LLM trained on a generic corpus of data or may be an LLM specifically trained for summarizing queries. The LLM 320 may use the generative prompt 310 as an input and the hypothetical summary 315 as a target output (e.g., a target format for the output of the LLM 320). The LLM output may represent a summary of the natural language query 305. The processing device may input the summary into an embedding model 325 for embedding the summary in a vector space. The embedding model 325 may output an embedding vector 330 based on the summary of the natural language query 305. The processing device, vector database, or both may use the embedding vector 330 and the vector space to determine relevant data stories. For example, the vector space may include embedded vectors representing summaries of data for a tenant of a multi-tenant database system. In some cases, the vector database may maintain separate vector spaces for different tenants to silo the data summaries for the different tenants. The closeness of the vector embedding for the natural language query 305 to one or more data summary vectors (e.g., corresponding to query response portions) in the vector space may indicate potential answers to the natural language query 305.

FIG. 3B shows an example of a process 300-b that supports a query procedure. The process 300-b may query a vector database for relevant summary data. A processing device (e.g., a single device or a system of devices), such as a processing device 205 as described with reference to FIG. 2, may perform the process 300-b. The processing device may communicate with the vector database.

The processing device may perform a semantic search 335 on the vector database. For example, the processing device may use a vector embedding for a natural language query to search a vector space of the vector database for relevant vectors. In some cases, the processing device may use any technique for determining one or more closest vectors to the vector embedding for the natural language query. The processing device may determine a set of ranked matches 340 corresponding to a set of vectors relatively close to (e.g., within a threshold distance of) the vector embedding for the natural language query. The processing device may use the ranked matches 340 to determine the corresponding matched metrics 345. For example, each match in the ranked matches 340 may be an example of a vector representing a data summary. The data summary may relate to one or more data metrics in a database system. The processing device may use the ranked matches 340 to identify the corresponding matched metrics 345. Such matched metrics 345 may indicate potential answers to the natural language query. For example, the matched metrics 345 may indicate one or more data metrics relating to, or acting as driving factors for, a metric asked about in the natural language query.

FIG. 3C shows an example of a process 300-c that supports metric expansion. The process 300-c may expand the metrics involved in the query process to other metrics that are relevant and affect a current metric. For example, a natural language query may ask about a first set of metrics. The process 300-c may expand the query answering process to involve a second set of metrics that relate to, or otherwise affect, at least one of the first set of metrics in a first recursive step. In a second recursive step, the process 300-c may expand the query answering to involve a third set of metrics that relate to, or otherwise affect, at least one of the second set of metrics. The process 300-c may involve any quantity of recursive steps. For example, the process 300-c may have a threshold depth for the recursion to reduce a processing overhead and latency associated with answering the natural language query. A processing device (e.g., a single device or a system of devices), such as a processing device 205 as described with reference to FIG. 2, may perform the process 300-c.

The processing device may generate a generative prompt 350 based on the natural language query (e.g., a natural language query 305) and one or more metric resolved from the natural language query (e.g., matched metrics 345). The processing device may input the generative prompt 350 into an LLM to determine adjacent related metrics 355 that affect (or may affect) the provided metrics. In some cases, the LLM may be trained using CRM data, tenant-specific data, or similar data to better understand relationships between data metrics. The processing device may generate one or more summaries 360 for the adjacent related metrics 355, for example, using an LLM. In some cases, the processing device may generate the one or more summaries 360 using a similar process to the process 300-a. The processing device may input the one or more summaries 360 into an embedding model 365 (e.g., the embedding model 325) to obtain one or more embedding vectors 370. The processing device may use the process 300-b to determine matched metrics 345 based on the additional embedding vectors 370. For example, the processing device may recursively perform the process 300-c and the process 300-b to expand the set of data metrics for analysis.

FIG. 3D shows an example of a process 300-d that supports question answering. The process 300-d may combine the metrics determined during the recursive process to generate an answer to a natural language query (e.g., the natural language query 305). A processing device (e.g., a single device or a system of devices), such as a processing device 205 as described with reference to FIG. 2, may perform the process 300-d.

The processing device may perform matched and adjacent metric grounding 375 to ground the query response with actual metric data from the database system. The processing device may generate a generative prompt 380 with the natural language query 305, the grounding data, and instructions for answering the query. The processing device may input the generative prompt 380 into an LLM to obtain an answer 390 to the natural language query 305. The answer 390 may be based on a combination of the matched and adjacent metrics and may be formatted based on the instructions to provide a clear, concise answer to the natural language query 305. The processing device may send the answer 390 in response to the natural language query 305 for display via a UI of a user device.

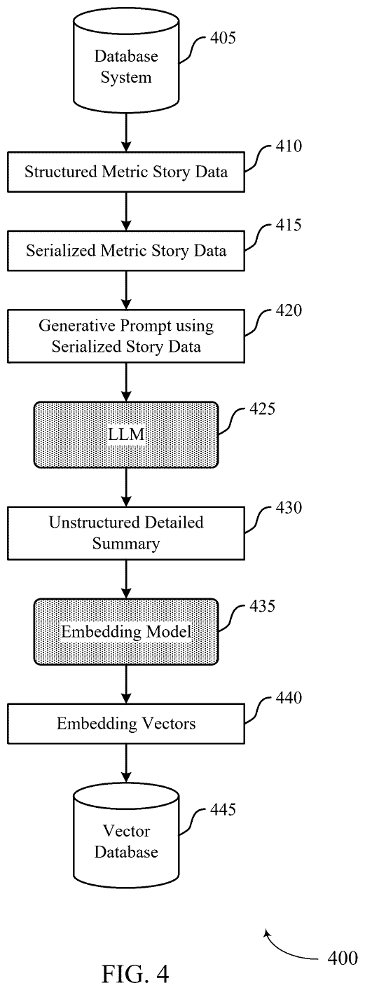

FIG. 4 shows an example of an offline indexing procedure 400 that supports recursive multi-metric expansion for queries in accordance with aspects of the present disclosure. The offline indexing procedure 400 may create and maintain a vector database 445 based on data metrics tracked at a database system 405. The database system 405 may be an example of a data center 120, a cloud platform 115, or a database system 245 as described with reference to FIGS. 1 and 2. For example, the database system 405 may be a CRM system or another enterprise data system. The vector database 445 may be a component of the database system 405 or may be separate from the database system 405. The vector database 445 may track vectors for one or more vector spaces to support answering metric-related questions. For example, the vectors may represent semantic summaries of information at the database system 405. A system including the database system 405 and the vector database 445 may use an LLM to create summaries of the data from the database system 405 and embed the summaries as vectors in the vector database 445. Accordingly, the vector database 445 may summarize metrics, trends, or other data from the database system 405 for improved querying.

One or more processing devices, such as a processing device 205 as described with reference to FIG. 2, a database server, or any other device, may perform the offline indexing procedure 400. The one or more processing devices may perform the offline indexing procedure 400 as a background operation in a CRM system. In some examples, the devices may perform initial vector database 445 creation and then may periodically or aperiodically update the vector database 445 to maintain synchronicity between the vectors of the vector database 445 and the information stored at the database system 405. In some examples, the devices may update the vector database 445 based on an update schedule (e.g., when processing resources are available to perform the updates as background operations), an update to the database system 405 triggering a corresponding update to the vector database 445, or a query for the vector database 445 triggering an update to the vector database 445 to ensure synchronicity before resolving the query.

At 410, the one or more processing devices may retrieve structured metric story data from the database system 405. In some cases, the processing devices may query the database system 405 to retrieve the structured metric story data. In some other cases, the processing devices may generate the structured metric story data based on data metrics stored at the database system 405. The structured metric story data may indicate patterns or other information relating to data metrics stored at the database system 405 for a specific tenant or organization. For example, the structured metric story data may indicate associated trends for different data metrics. One example of structured metric story data may indicate that a customer satisfaction metric has decreased by 12% while service requests for a first product increased by 22%. Such a story may indicate directly related trends in data metrics. However, the story may not indicate other related trends (e.g., not directly related, but inherently related through other metrics). The stories may index the data from the database system 405 by different data metrics (e.g., individual metrics).

At 415, the one or more processing devices may serialize the structured metric story data. Serializing the structured metric story data may involve cleaning the data to support insertion in an LLM prompt. At 420, the one or more processing devices may create—or otherwise determine—a generative prompt for an LLM using the serialized story data. For example, the generative prompt may request the LLM 425 to summarize the serialized metric story data. The one or more processing devices may input the generative prompt into the LLM 425. The LLM 425 may process the generative prompt and, at 430, may output an unstructured detailed summary based on the generative prompt. The LLM 425 may be an example of an out-of-the-box LLM or may be an LLM trained specifically to summarize story data for a database system 405.

The one or more processing devices may input the unstructured detailed summary into an embedding model 435. The embedding model 435 may generate a vector representing the unstructured detailed summary for a vector space. At 440, the processing devices may embed the vector into the vector space. The vector database 445 may store information for one or more vector spaces. For example, the vector database 445 may store different vector spaces for different tenants or organizations of the database system 405. The vector database 445 may additionally store the unstructured detailed summaries corresponding to the vectors in the database. The vector database 445 may use the vectors to determine relevant information (e.g., based on distances between vectors or other closeness measurements) and may use the related unstructured detailed summaries to determine summary information corresponding to the vectors.

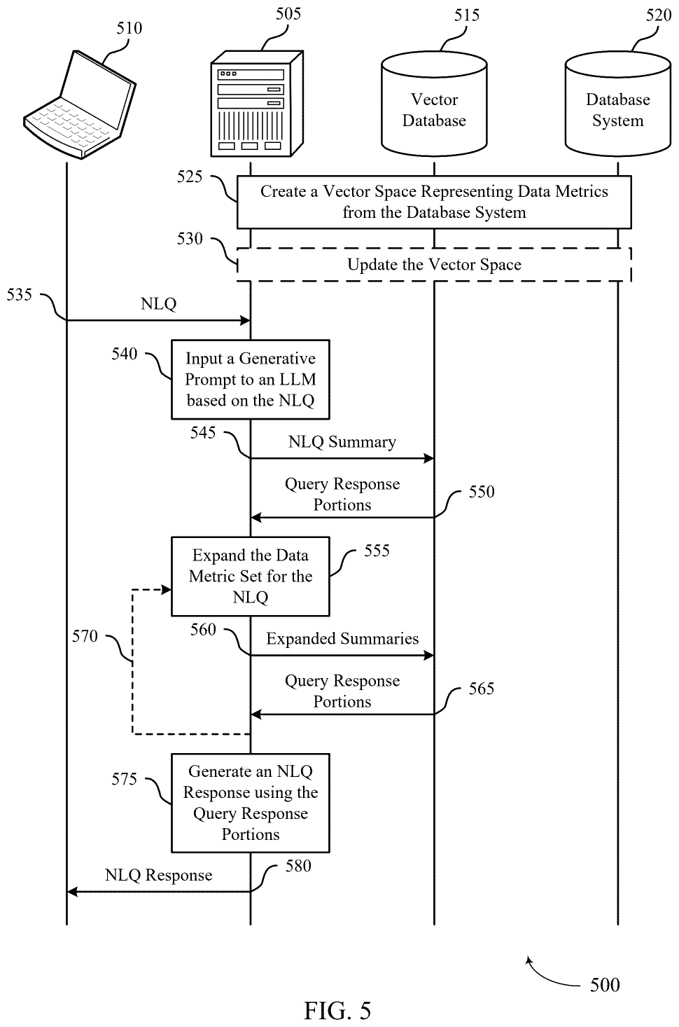

FIG. 5 shows an example of a process flow 500 that supports recursive multi-metric expansion for queries in accordance with aspects of the present disclosure. The process flow 500 may be implemented by a system including one or more processing devices 505, one or more user devices 510, one or more vector databases 515, and a database system 520. The system may support CRM operations, including data tracking and analysis. A processing device 505 may be an example of a computing device, an application server, a database server, a cloud-based server or service, a worker server, a server cluster, a virtual machine, a container, a network device, a user device, or any combination of these or other computing devices or systems. The user device 510 may access the CRM system or service. The user device 510 may be an example of a laptop, desktop computer, mobile device, smartphone, smartwatch, tablet, virtual reality (VR) device, or any other smart device. The user device 510 may include a UI that can present information (e.g., visually, audibly) corresponding to query functionality, as described herein with reference to FIGS. 1 through 4. The vector database 515 and the database system 520 may track data metrics, summaries of data metrics, and embedded vectors representing trends in data metrics. Alternative examples of the following may be implemented, where some processes are performed in a different order than described or are not performed at all. In some examples, processes may include additional features not mentioned below, or further processes may be added. Additionally, or alternatively, one or more operations described herein as performed by the processing device 505 may instead be performed by the user device 510 (e.g., locally), the database system 520, or the vector database 515.

At 525, the processing device 505 may create a vector space at the vector database 515 representing information relating to data metrics from the database system 520. The vector database 515 may be associated with the database system 520. The processing device 505 may perform a procedure, such as an offline indexing procedure 400 as described with reference to FIG. 4, to vectorize information relating to the database system 520. In some examples, the processing device 505 may retrieve, from the database system 520 (e.g., a multi-tenant database system), data metrics associated with data for a CRM system. The processing device 505 may input, to an LLM (e.g., an off-the-shelf LLM or specifically trained LLM), one or more generative prompts based on the data metrics. The LLM may output a set of summaries of the data for the CRM system in response to the generative prompts. The processing device 505 may embed the set of summaries as vectors in a vector space of the vector database 515. Accordingly, the vector space may represent summaries of data from the database system 520. In some cases, the data may correspond to a first tenant of the database system 520 (e.g., a multi-tenant database system securely storing data for multiple different tenants), and the vector space may be specific to this first tenant. The vector database 515 may track different vector spaces (e.g., siloed vector spaces) corresponding to different tenants of the database system 520. Accordingly, the vector database 515 may support tenant-specific data analysis using the vectors.

In some cases, at 530, the processing device 505 may update the vectors embedded in a vector space of the vector database 515. For example, the processing device 505 may update one or more vectors based on an update to data in the database system 520 (e.g., updated CRM data, updated user activity data, or other updated information). The processing device 505 may update one or more vectors according to a periodicity, a non-periodic schedule, or a trigger (e.g., a user query, a change to the data in the database system 520). By updating the vector database 515, the processing device 505 may maintain synchronicity (or relative synchronicity) between the vector database 515 and the database system 520.

At 535, a user operating the user device 510 may input a query (e.g., a natural language query) for the system. The user may input the query into a UI of the user device 510. The UI may support natural language prompt inputs and outputting natural language answers in response. The processing device 505 may receive, from the user device 510, the natural language query associated with a data metric of the database system 520. For example, the natural language query may include a question asking why a change occurred to the data metric in the database system 520.

At 540, the processing device 505 may create a generative prompt for an LLM based on the natural language query. The processing device 505 may input, to the LLM, the generative prompt based on the natural language query. The LLM may output a summary of the natural language query (e.g., for vector embedding). The LLM may be the same as, or different from, the LLM used to create the vector space(s).

At 545, the processing device 505 may send the summary of the natural language query for vector embedding at the vector database 515. At 550, the processing device 505 may receive, from the vector database 515, one or more query response portions based on the vector embedding of the summary. For example, the vector database 515 may determine respective distances between a vector representing the summary of the natural language query and one or more vectors representing the one or more query response portions. In some cases, the vector database 515 may return query response portions corresponding to vectors that are within a threshold distance from the vector summary. In some other cases, the vector database 515 may return a threshold quantity of query response portions corresponding to vectors closest to the vector summary.

At 555, the processing device 505 may expand a data metric set for analysis. For example, the processing device 505 may create an additional generative prompt associated with expanding the data metric set for the natural language query based on the data metric associated with the natural language query to determine adjacent or underlying metrics that may help answer the natural language query. The processing device 505 may input, to an LLM (e.g., the same LLM or a different LLM), the additional generative prompt to expand the data metric set. The LLM may output a set of additional summaries for vector embedding associated with a set of additional data metrics of the database system 520. For example, the LLM may predict other metrics that may affect the data metric of the natural language query.

At 560, the processing device 505 may send the set of additional summaries for vector embedding at the vector database 515. At 565, the processing device 505 may receive, from the vector database 515, a set of additional query response portions based on the set of additional summaries. For example, the vector database 515 may determine additional query response portions corresponding to vectors that are relatively close to vectors for the set of additional summaries.

In some examples, at 570, the processing device 505 may recursively expand the data metric set for analysis. For example, the processing device 505 may determine other data metrics that are adjacent or underlying metrics to the expanded set of data metrics. The quantity of sets of additional summaries for vector embedding may correspond to a threshold depth for recursive expansion of the data metric set. In some examples, a user may define the threshold depth. In some other examples, the threshold depth may be pre-configured or set as a default value. Additionally, or alternatively, the threshold depth may be based on a threshold processing overhead allocated for the recursive multi-metric expansion.

At 575, the processing device 505 may generate an answer to the natural language query using the query response portions. For example, the processing device 505 may input a generative prompt to an LLM based on the natural language query and the query response portions, where the LLM may output a response to the natural language query. At 580, the processing device 505 may transmit, to the user device 510, the response to the natural language query. The user device 510 may display the response via the UI to the user, such that the user may view the answer to the natural language query. The response may provide additional details and information based on expanding the data metric set for analysis.

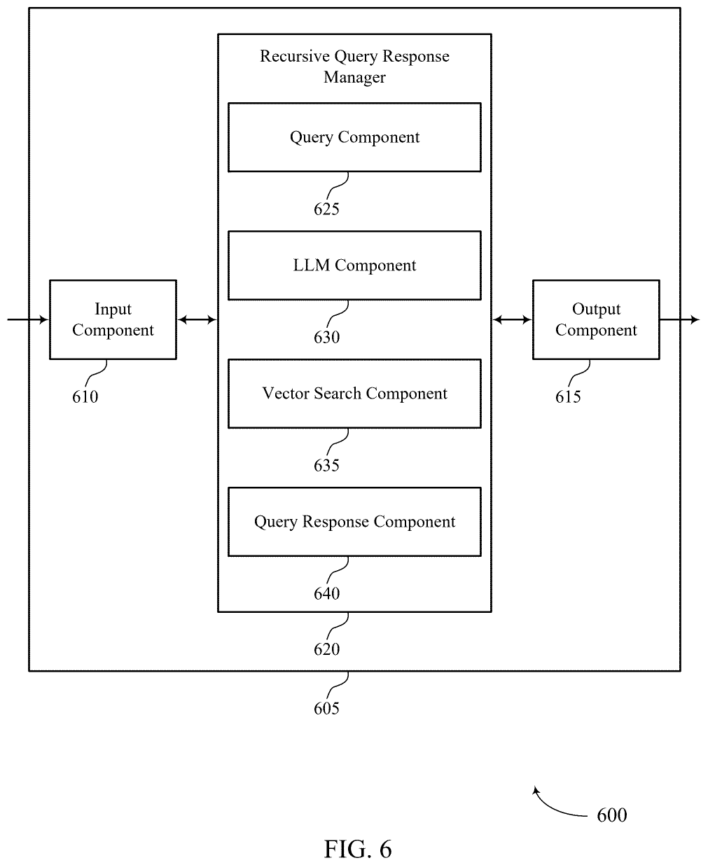

FIG. 6 shows a block diagram 600 of a device 605 that supports recursive multi-metric expansion for queries in accordance with aspects of the present disclosure. The device 605 may include an input component 610, an output component 615, and a recursive query response manager 620. The device 605 may be an example of a processing device or system, such as an application server, a database server, a cloud-based server or service, a worker server, a server cluster, a virtual machine, a container, a network device, a user device, or any combination of these or other computing devices. The device 605, or one of more components of the device 605 (e.g., the input component 610, the output component 615, the recursive query response manager 620), may include at least one processor, which may be coupled with at least one memory, to support the described techniques. Each of these components may be in communication with one another (e.g., via one or more buses).

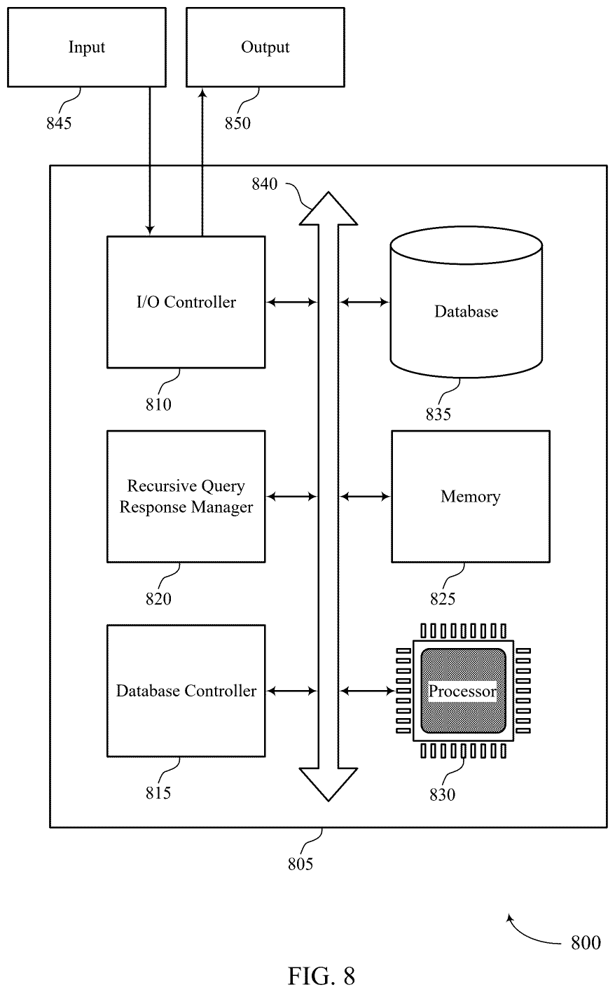

The input component 610 may manage input signals for the device 605. For example, the input component 610 may identify input signals based on an interaction with a modem, a keyboard, a mouse, a touchscreen, or any other device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the device 605 for processing. For example, the input component 610 may transmit input signals to the recursive query response manager 620 to support recursive multi-metric expansion for queries. In some cases, the input component 610 may be a component of an input/output (I/O) controller 810 as described with reference to FIG. 8.

The output component 615 may manage output signals for the device 605. For example, the output component 615 may receive signals from other components of the device 605, such as the recursive query response manager 620, and may transmit these signals to other components or devices. In some examples, the output component 615 may transmit output signals for display in a user interface, for storage in a database or data store, for further processing at a server or server cluster, or for any other processes at any number of devices or systems. In some cases, the output component 615 may be a component of an I/O controller 810 as described with reference to FIG. 8.

The recursive query response manager 620 may include a query component 625, an LLM component 630, a vector search component 635, a query response component 640, or any combination thereof. In some examples, the recursive query response manager 620, or various components thereof, may be configured to perform various operations (e.g., receiving, monitoring, transmitting) using or otherwise in cooperation with the input component 610, the output component 615, or both. For example, the recursive query response manager 620 may receive information from the input component 610, send information to the output component 615, or be integrated in combination with the input component 610, the output component 615, or both to receive information, transmit information, or perform various other operations as described herein.

The recursive query response manager 620 may support multi-metric query responses in accordance with examples as disclosed herein. The query component 625 may be configured to support receiving, from a user device, a natural language query associated with a data metric of a multi-tenant database system. The LLM component 630 may be configured to support inputting, to an LLM, a first generative prompt based on the natural language query, the LLM outputting a summary of the natural language query for vector embedding. The vector search component 635 may be configured to support receiving, from a vector database associated with the multi-tenant database system, one or more query response portions based on respective distances between a vector representing the summary of the natural language query and one or more vectors representing the one or more query response portions. The LLM component 630 may be further configured to support inputting, to the LLM, a second generative prompt associated with expanding a data metric set for the natural language query based on the data metric, the LLM outputting a first set of additional summaries for the vector embedding associated with a first set of additional data metrics of the multi-tenant database system. The vector search component 635 may be further configured to support receiving, from the vector database, a first set of additional query response portions based on the first set of additional summaries. The query response component 640 may be configured to support transmitting, to the user device, a response to the natural language query based on the one or more query response portions and the first set of additional query response portions.

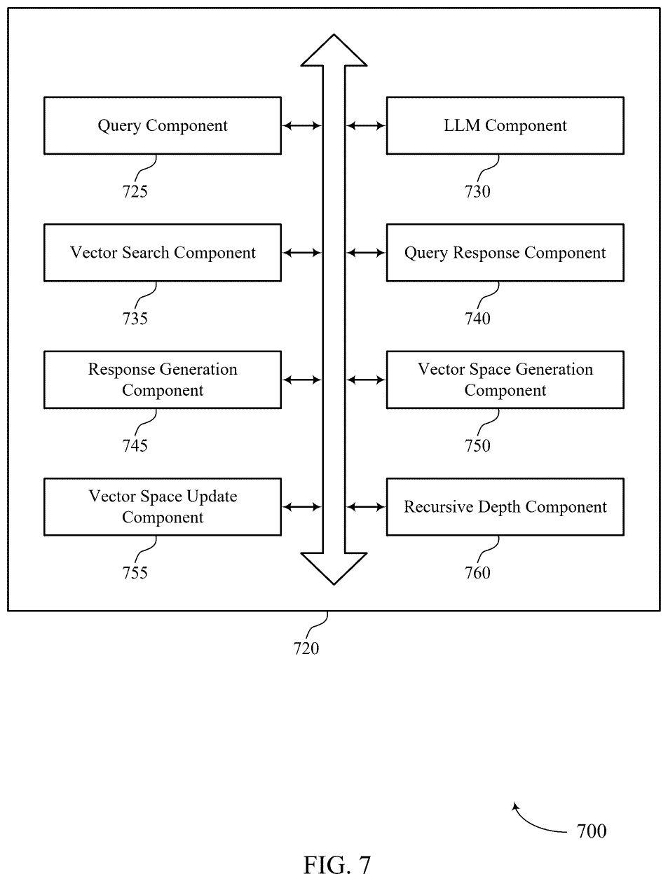

FIG. 7 shows a block diagram 700 of a recursive query response manager 720 that supports recursive multi-metric expansion for queries in accordance with aspects of the present disclosure. The recursive query response manager 720 may be an example of aspects of a recursive query response manager 620 as described herein. The recursive query response manager 720, or various components thereof, may be an example of means for performing various aspects of recursive multi-metric expansion for queries as described herein. For example, the recursive query response manager 720 may include a query component 725, an LLM component 730, a vector search component 735, a query response component 740, a response generation component 745, a vector space generation component 750, a vector space update component 755, a recursive depth component 760, or any combination thereof. Each of these components, or components of subcomponents thereof (e.g., one or more processors, one or more memories), may communicate, directly or indirectly, with one another (e.g., via one or more buses).

The recursive query response manager 720 may support multi-metric query responses in accordance with examples as disclosed herein. The query component 725 may be configured to support receiving, from a user device, a natural language query associated with a data metric of a multi-tenant database system. The LLM component 730 may be configured to support inputting, to an LLM, a first generative prompt based on the natural language query, the LLM outputting a summary of the natural language query for vector embedding. The vector search component 735 may be configured to support receiving, from a vector database associated with the multi-tenant database system, one or more query response portions based on respective distances between a vector representing the summary of the natural language query and one or more vectors representing the one or more query response portions. In some examples, the LLM component 730 may be configured to support inputting, to the LLM, a second generative prompt associated with expanding a data metric set for the natural language query based on the data metric, the LLM outputting a first set of additional summaries for the vector embedding associated with a first set of additional data metrics of the multi-tenant database system. In some examples, the vector search component 735 may be configured to support receiving, from the vector database, a first set of additional query response portions based on the first set of additional summaries. The query response component 740 may be configured to support transmitting, to the user device, a response to the natural language query based on the one or more query response portions and the first set of additional query response portions.

In some examples, the LLM component 730 may be configured to support inputting, to the LLM, a third generative prompt associated with a recursive expansion of the data metric set for the natural language query based on the first set of additional data metrics, the LLM outputting a second set of additional summaries for the vector embedding associated with a second set of additional data metrics of the multi-tenant database system. In some examples, the vector search component 735 may be configured to support receiving, from the vector database, a second set of additional query response portions based on the second set of additional summaries, where the response to the natural language query is further based on the second set of additional query response portions.

In some examples, a quantity of sets of additional summaries for the vector embedding corresponds to a threshold depth for the recursive expansion of the data metric set. In some examples, the recursive depth component 760 may be configured to support receiving, from the user device, an indication of the threshold depth for the recursive expansion of the data metric set. In some other examples, the recursive depth component 760 may be configured to support setting the threshold depth for the recursive expansion of the data metric set to a default value.

In some examples, the LLM component 730 may be configured to support inputting, to the LLM, a fourth generative prompt associated with broadening from the data metric to the first set of additional data metrics, the LLM outputting a set of non-specific metrics relating to the data metric. In some examples, the vector search component 735 may be configured to support receiving, from the vector database, the first set of additional data metrics based on the set of non-specific metrics relating to the data metric, where the second generative prompt is based on the first set of additional data metrics.

In some examples, the response generation component 745 may be configured to support inputting, to the LLM, a fifth generative prompt based on the natural language query, the one or more query response portions, and the first set of additional query response portions, where the LLM outputs the response to the natural language query.

In some examples, the vector space generation component 750 may be configured to support retrieving, from the multi-tenant database system, a set of multiple data metrics associated with data for a CRM system. In some examples, the vector space generation component 750 may be configured to support inputting, to the LLM, one or more generative prompts based on the set of multiple data metrics, the LLM outputting a set of multiple summaries of the data for the CRM system. In some examples, the vector space generation component 750 may be configured to support embedding the set of multiple summaries as a set of multiple vectors in a vector space corresponding to the vector database associated with the multi-tenant database system, where the set of multiple vectors includes the one or more vectors representing the one or more query response portions. In some examples, the vector space update component 755 may be configured to support updating the set of multiple vectors embedded in the vector space based on an update to the data for the CRM system. In some examples, the data for the CRM system corresponds to a first tenant of a set of multiple tenants of the multi-tenant database system. In some such examples, the vector database corresponds to data summaries for the first tenant.

In some examples, the natural language query associated with the data metric includes a question asking why a change occurred to the data metric in the multi-tenant database system. In some examples, the one or more query response portions indicate one or more changes to other data metrics in the multi-tenant database system that affected the data metric in the multi-tenant database system.

FIG. 8 shows a diagram of a system 800 including a device 805 that supports recursive multi-metric expansion for queries in accordance with aspects of the present disclosure. The device 805 may be an example of or include components of a device 605 or a processing device or system, as described herein. The device 805 may include components for bi-directional data communications including components for transmitting and receiving communications, such as a recursive query response manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In some other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In some other cases, a memory controller may be integrated into the processor 830. The processor 830 may be configured to execute computer-readable instructions stored in at least one memory 825 to perform various functions (e.g., functions or tasks supporting recursive multi-metric expansion for queries). The processor 830 may be an example of a single processor or multiple processors. For example, the device 805 may include one or more processors 830.

The recursive query response manager 820 may support multi-metric query responses in accordance with examples as disclosed herein. For example, the recursive query response manager 820 may be configured to support receiving, from a user device, a natural language query associated with a data metric of a multi-tenant database system. The recursive query response manager 820 may be configured to support inputting, to an LLM, a first generative prompt based on the natural language query, the LLM outputting a summary of the natural language query for vector embedding. The recursive query response manager 820 may be configured to support receiving, from a vector database associated with the multi-tenant database system, one or more query response portions based on respective distances between a vector representing the summary of the natural language query and one or more vectors representing the one or more query response portions. The recursive query response manager 820 may be configured to support inputting, to the LLM, a second generative prompt associated with expanding a data metric set for the natural language query based on the data metric, the LLM outputting a first set of additional summaries for the vector embedding associated with a first set of additional data metrics of the multi-tenant database system. The recursive query response manager 820 may be configured to support receiving, from the vector database, a first set of additional query response portions based on the first set of additional summaries. The recursive query response manager 820 may be configured to support transmitting, to the user device, a response to the natural language query based on the one or more query response portions and the first set of additional query response portions.

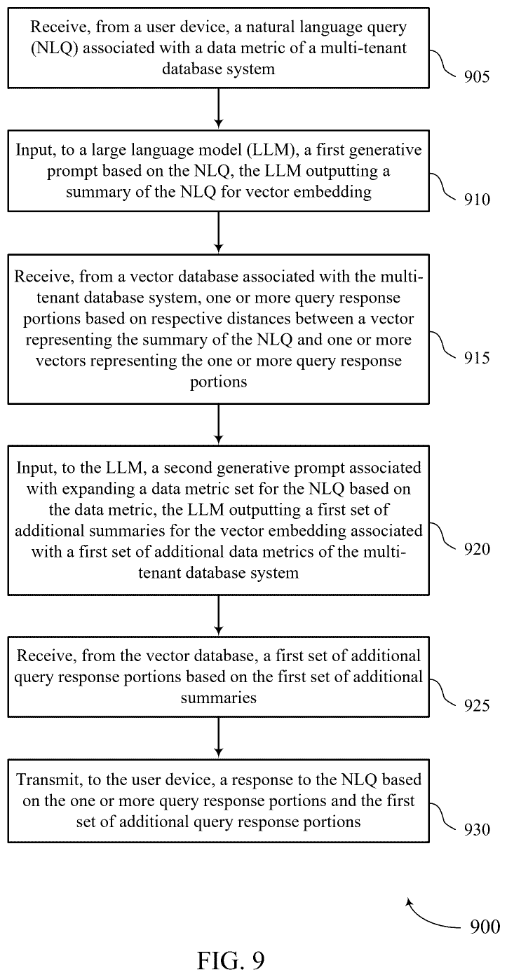

FIG. 9 shows a flowchart illustrating a method 900 that supports recursive multi-metric expansion for queries in accordance with aspects of the present disclosure. The operations of the method 900 may be implemented by a processing device or system (or components of a processing device or system) as described herein. For example, the operations of the method 900 may be performed by a processing device or system as described with reference to FIGS. 1 through 8. In some examples, a processing device or system may execute a set of instructions to control the functional elements of the processing device or system to perform the described functions. Additionally, or alternatively, the processing device or system may perform aspects of the described functions using special-purpose hardware.

At 905, the method may include receiving, from a user device, a natural language query associated with a data metric of a multi-tenant database system. The operations of 905 may be performed in accordance with examples as disclosed herein. In some examples, aspects of the operations of 905 may be performed by a query component 725 as described with reference to FIG. 7.

At 910, the method may include inputting, to an LLM, a first generative prompt based on the natural language query. The LLM may output a summary of the natural language query for vector embedding. The operations of 910 may be performed in accordance with examples as disclosed herein. In some examples, aspects of the operations of 910 may be performed by an LLM component 730 as described with reference to FIG. 7.

At 915, the method may include receiving, from a vector database associated with the multi-tenant database system, one or more query response portions based on respective distances between a vector representing the summary of the natural language query and one or more vectors representing the one or more query response portions. The operations of 915 may be performed in accordance with examples as disclosed herein. In some examples, aspects of the operations of 915 may be performed by a vector search component 735 as described with reference to FIG. 7.

At 920, the method may include inputting, to the LLM, a second generative prompt associated with expanding a data metric set for the natural language query based on the data metric. The LLM may output a first set of additional summaries for the vector embedding associated with a first set of additional data metrics of the multi-tenant database system. The operations of 920 may be performed in accordance with examples as disclosed herein. In some examples, aspects of the operations of 920 may be performed by an LLM component 730 as described with reference to FIG. 7.

At 925, the method may include receiving, from the vector database, a first set of additional query response portions based on the first set of additional summaries. The operations of 925 may be performed in accordance with examples as disclosed herein. In some examples, aspects of the operations of 925 may be performed by a vector search component 735 as described with reference to FIG. 7.

At 930, the method may include transmitting, to the user device, a response to the natural language query based on the one or more query response portions and the first set of additional query response portions. The operations of 930 may be performed in accordance with examples as disclosed herein. In some examples, aspects of the operations of 930 may be performed by a query response component 740 as described with reference to FIG. 7.

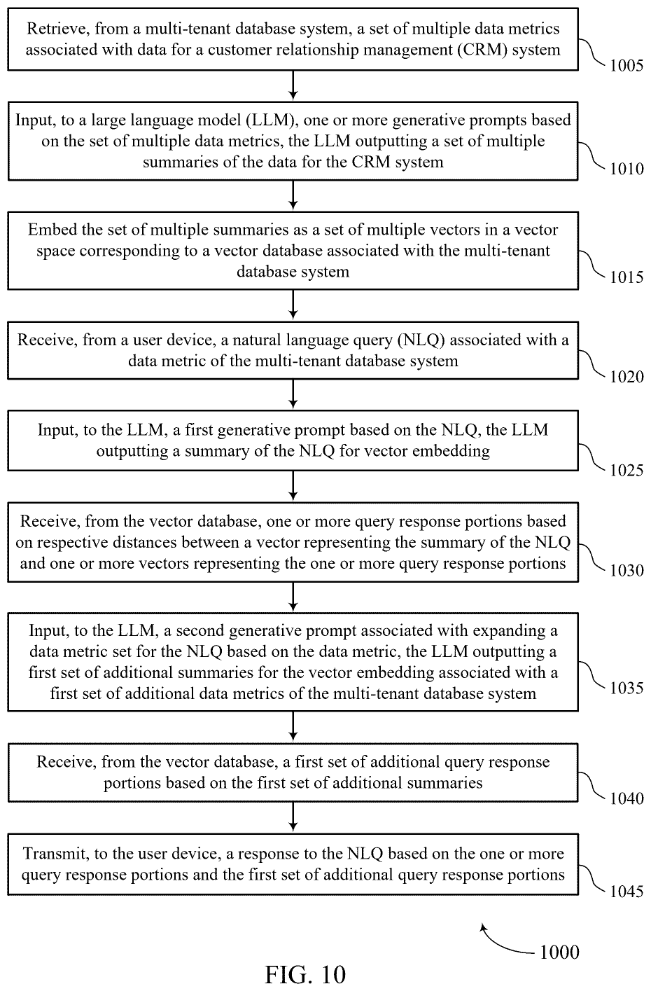

FIG. 10 shows a flowchart illustrating a method 1000 that supports recursive multi-metric expansion for queries in accordance with aspects of the present disclosure. The operations of the method 1000 may be implemented by a processing device or system (or components of a processing device or system) as described herein. For example, the operations of the method 1000 may be performed by a processing device or system as described with reference to FIGS. 1 through 8. In some examples, a processing device or system may execute a set of instructions to control the functional elements of the processing device or system to perform the described functions. Additionally, or alternatively, the processing device or system may perform aspects of the described functions using special-purpose hardware.

At 1005, the method may include retrieving, from a multi-tenant database system, a set of multiple data metrics associated with data for a CRM system. The operations of 1005 may be performed in accordance with examples as disclosed herein. In some examples, aspects of the operations of 1005 may be performed by a vector space generation component 750 as described with reference to FIG. 7.

At 1010, the method may include inputting, to an LLM, one or more generative prompts based on the set of multiple data metrics. The LLM may output a set of multiple summaries of the data for the CRM system. The operations of 1010 may be performed in accordance with examples as disclosed herein. In some examples, aspects of the operations of 1010 may be performed by a vector space generation component 750 as described with reference to FIG. 7.

At 1015, the method may include embedding the set of multiple summaries as a set of multiple vectors in a vector space corresponding to a vector database associated with the multi-tenant database system. The operations of 1015 may be performed in accordance with examples as disclosed herein. In some examples, aspects of the operations of 1015 may be performed by a vector space generation component 750 as described with reference to FIG. 7.

At 1020, the method may include receiving, from a user device, a natural language query associated with a data metric of the multi-tenant database system. The operations of 1020 may be performed in accordance with examples as disclosed herein. In some examples, aspects of the operations of 1020 may be performed by a query component 725 as described with reference to FIG. 7.

At 1025, the method may include inputting, to the LLM, a first generative prompt based on the natural language query. The LLM may output a summary of the natural language query for vector embedding. The operations of 1025 may be performed in accordance with examples as disclosed herein. In some examples, aspects of the operations of 1025 may be performed by an LLM component 730 as described with reference to FIG. 7.

At 1030, the method may include receiving, from the vector database associated with the multi-tenant database system, one or more query response portions based on respective distances between a vector representing the summary of the natural language query and one or more vectors representing the one or more query response portions, where the set of multiple vectors in the vector database includes the one or more vectors representing the one or more query response portions. The operations of 1030 may be performed in accordance with examples as disclosed herein. In some examples, aspects of the operations of 1030 may be performed by a vector search component 735 as described with reference to FIG. 7.

At 1035, the method may include inputting, to the LLM, a second generative prompt associated with expanding a data metric set for the natural language query based on the data metric. The LLM may output a first set of additional summaries for the vector embedding associated with a first set of additional data metrics of the multi-tenant database system. The operations of 1035 may be performed in accordance with examples as disclosed herein. In some examples, aspects of the operations of 1035 may be performed by an LLM component 730 as described with reference to FIG. 7.

At 1040, the method may include receiving, from the vector database, a first set of additional query response portions based on the first set of additional summaries. The operations of 1040 may be performed in accordance with examples as disclosed herein. In some examples, aspects of the operations of 1040 may be performed by a vector search component 735 as described with reference to FIG. 7.

At 1045, the method may include transmitting, to the user device, a response to the natural language query based on the one or more query response portions and the first set of additional query response portions. The operations of 1045 may be performed in accordance with examples as disclosed herein. In some examples, aspects of the operations of 1045 may be performed by a query response component 740 as described with reference to FIG. 7.

A method for multi-metric query responses is described. The method may include receiving, from a user device, a natural language query associated with a data metric of a multi-tenant database system and inputting, to an LLM, a first generative prompt based on the natural language query, the LLM outputting a summary of the natural language query for vector embedding. The method may further include receiving, from a vector database associated with the multi-tenant database system, one or more query response portions based on respective distances between a vector representing the summary of the natural language query and one or more vectors representing the one or more query response portions and inputting, to the LLM, a second generative prompt associated with expanding a data metric set for the natural language query based on the data metric, the LLM outputting a first set of additional summaries for the vector embedding associated with a first set of additional data metrics of the multi-tenant database system. The method may further include receiving, from the vector database, a first set of additional query response portions based on the first set of additional summaries and transmitting, to the user device, a response to the natural language query based on the one or more query response portions and the first set of additional query response portions.

An apparatus for multi-metric query responses is described. The apparatus may include one or more memories storing processor executable code and one or more processors coupled with the one or more memories. The one or more processors may individually or collectively be operable to execute the code to cause the apparatus to receive, from a user device, a natural language query associated with a data metric of a multi-tenant database system and input, to an LLM, a first generative prompt based on the natural language query, the LLM outputting a summary of the natural language query for vector embedding. The one or more processors may individually or collectively be further operable to execute the code to cause the apparatus to receive, from a vector database associated with the multi-tenant database system, one or more query response portions based on respective distances between a vector representing the summary of the natural language query and one or more vectors representing the one or more query response portions and input, to the LLM, a second generative prompt associated with expanding a data metric set for the natural language query based on the data metric, the LLM outputting a first set of additional summaries for the vector embedding associated with a first set of additional data metrics of the multi-tenant database system. The one or more processors may individually or collectively be further operable to execute the code to cause the apparatus to receive, from the vector database, a first set of additional query response portions based on the first set of additional summaries and transmit, to the user device, a response to the natural language query based on the one or more query response portions and the first set of additional query response portions.

Another apparatus for multi-metric query responses is described. The apparatus may include means for receiving, from a user device, a natural language query associated with a data metric of a multi-tenant database system and means for inputting, to an LLM, a first generative prompt based on the natural language query, the LLM outputting a summary of the natural language query for vector embedding. The apparatus may further include means for receiving, from a vector database associated with the multi-tenant database system, one or more query response portions based on respective distances between a vector representing the summary of the natural language query and one or more vectors representing the one or more query response portions and means for inputting, to the LLM, a second generative prompt associated with expanding a data metric set for the natural language query based on the data metric, the LLM outputting a first set of additional summaries for the vector embedding associated with a first set of additional data metrics of the multi-tenant database system. The apparatus may further include means for receiving, from the vector database, a first set of additional query response portions based on the first set of additional summaries and means for transmitting, to the user device, a response to the natural language query based on the one or more query response portions and the first set of additional query response portions.

A non-transitory computer-readable medium storing code for multi-metric query responses is described. The code may include instructions executable by one or more processors to receive, from a user device, a natural language query associated with a data metric of a multi-tenant database system and input, to an LLM, a first generative prompt based on the natural language query, the LLM outputting a summary of the natural language query for vector embedding. The code may include instructions further executable by the one or more processors to receive, from a vector database associated with the multi-tenant database system, one or more query response portions based on respective distances between a vector representing the summary of the natural language query and one or more vectors representing the one or more query response portions and input, to the LLM, a second generative prompt associated with expanding a data metric set for the natural language query based on the data metric, the LLM outputting a first set of additional summaries for the vector embedding associated with a first set of additional data metrics of the multi-tenant database system. The code may include instructions further executable by the one or more processors to receive, from the vector database, a first set of additional query response portions based on the first set of additional summaries and transmit, to the user device, a response to the natural language query based on the one or more query response portions and the first set of additional query response portions.

Some examples of the method, apparatuses, and non-transitory computer-readable medium described herein may further include operations, features, means, or instructions for inputting, to the LLM, a third generative prompt associated with a recursive expansion of the data metric set for the natural language query based on the first set of additional data metrics, the LLM outputting a second set of additional summaries for the vector embedding associated with a second set of additional data metrics of the multi-tenant database system, and receiving, from the vector database, a second set of additional query response portions based on the second set of additional summaries, where the response to the natural language query may be further based on the second set of additional query response portions.

In some examples of the method, apparatuses, and non-transitory computer-readable medium described herein, a quantity of sets of additional summaries for the vector embedding corresponds to a threshold depth for the recursive expansion of the data metric set.

Some examples of the method, apparatuses, and non-transitory computer-readable medium described herein may further include operations, features, means, or instructions for receiving, from the user device, an indication of the threshold depth for the recursive expansion of the data metric set.

Some examples of the method, apparatuses, and non-transitory computer-readable medium described herein may further include operations, features, means, or instructions for setting the threshold depth for the recursive expansion of the data metric set to a default value.

Some examples of the method, apparatuses, and non-transitory computer-readable medium described herein may further include operations, features, means, or instructions for inputting, to the LLM, a fourth generative prompt associated with broadening from the data metric to the first set of additional data metrics, the LLM outputting a set of non-specific metrics relating to the data metric. Some such examples of the method, apparatuses, and non-transitory computer-readable medium described herein may further include operations, features, means, or instructions for receiving, from the vector database, the first set of additional data metrics based on the set of non-specific metrics relating to the data metric, where the second generative prompt may be based on the first set of additional data metrics.

Some examples of the method, apparatuses, and non-transitory computer-readable medium described herein may further include operations, features, means, or instructions for inputting, to the LLM, a fifth generative prompt based on the natural language query, the one or more query response portions, and the first set of additional query response portions, where the LLM outputs the response to the natural language query.

Some examples of the method, apparatuses, and non-transitory computer-readable medium described herein may further include operations, features, means, or instructions for retrieving, from the multi-tenant database system, a set of multiple data metrics associated with data for a CRM system, inputting, to the LLM, one or more generative prompts based on the set of multiple data metrics, the LLM outputting a set of multiple summaries of the data for the CRM system, and embedding the set of multiple summaries as a set of multiple vectors in a vector space corresponding to the vector database associated with the multi-tenant database system, where the set of multiple vectors includes the one or more vectors representing the one or more query response portions.

Some examples of the method, apparatuses, and non-transitory computer-readable medium described herein may further include operations, features, means, or instructions for updating the set of multiple vectors embedded in the vector space based on an update to the data for the CRM system.

In some examples of the method, apparatuses, and non-transitory computer-readable medium described herein, the data for the CRM system corresponds to a first tenant of a set of multiple tenants of the multi-tenant database system and the vector database corresponds to data summaries for the first tenant.

In some examples of the method, apparatuses, and non-transitory computer-readable medium described herein, the natural language query associated with the data metric includes a question asking why a change occurred to the data metric in the multi-tenant database system.

In some examples of the method, apparatuses, and non-transitory computer-readable medium described herein, the one or more query response portions indicate one or more changes to other data metrics in the multi-tenant database system that affected the data metric in the multi-tenant database system.

The following provides an overview of aspects of the present disclosure:

Aspect 1: A method for multi-metric query responses, comprising: receiving, from a user device, a natural language query associated with a data metric of a multi-tenant database system; inputting, to an LLM, a first generative prompt based at least in part on the natural language query, the LLM outputting a summary of the natural language query for vector embedding; receiving, from a vector database associated with the multi-tenant database system, one or more query response portions based at least in part on respective distances between a vector representing the summary of the natural language query and one or more vectors representing the one or more query response portions; inputting, to the LLM, a second generative prompt associated with expanding a data metric set for the natural language query based at least in part on the data metric, the LLM outputting a first set of additional summaries for the vector embedding associated with a first set of additional data metrics of the multi-tenant database system; receiving, from the vector database, a first set of additional query response portions based at least in part on the first set of additional summaries; and transmitting, to the user device, a response to the natural language query based at least in part on the one or more query response portions and the first set of additional query response portions.

Aspect 2: The method of aspect 1, further comprising: inputting, to the LLM, a third generative prompt associated with a recursive expansion of the data metric set for the natural language query based at least in part on the first set of additional data metrics, the LLM outputting a second set of additional summaries for the vector embedding associated with a second set of additional data metrics of the multi-tenant database system; and receiving, from the vector database, a second set of additional query response portions based at least in part on the second set of additional summaries, wherein the response to the natural language query is further based at least in part on the second set of additional query response portions.

Aspect 3: The method of aspect 2, wherein a quantity of sets of additional summaries for the vector embedding corresponds to a threshold depth for the recursive expansion of the data metric set.

Aspect 4: The method of aspect 3, further comprising: receiving, from the user device, an indication of the threshold depth for the recursive expansion of the data metric set.

Aspect 5: The method of any of aspects 3 through 4, further comprising: setting the threshold depth for the recursive expansion of the data metric set to a default value.

Aspect 6: The method of any of aspects 1 through 5, further comprising: inputting, to the LLM, a fourth generative prompt associated with broadening from the data metric to the first set of additional data metrics, the LLM outputting a set of non-specific metrics relating to the data metric; and receiving, from the vector database, the first set of additional data metrics based at least in part on the set of non-specific metrics relating to the data metric, wherein the second generative prompt is based at least in part on the first set of additional data metrics.

Aspect 7: The method of any of aspects 1 through 6, further comprising: inputting, to the LLM, a fifth generative prompt based at least in part on the natural language query, the one or more query response portions, and the first set of additional query response portions, wherein the LLM outputs the response to the natural language query.

Aspect 8: The method of any of aspects 1 through 7, further comprising: retrieving, from the multi-tenant database system, a plurality of data metrics associated with data for a CRM system; inputting, to the LLM, one or more generative prompts based at least in part on the plurality of data metrics, the LLM outputting a plurality of summaries of the data for the CRM system; and embedding the plurality of summaries as a plurality of vectors in a vector space corresponding to the vector database associated with the multi-tenant database system, wherein the plurality of vectors comprises the one or more vectors representing the one or more query response portions.

Aspect 9: The method of aspect 8, further comprising: updating the plurality of vectors embedded in the vector space based at least in part on an update to the data for the CRM system.

Aspect 10: The method of any of aspects 8 through 9, wherein the data for the CRM system corresponds to a first tenant of a plurality of tenants of the multi-tenant database system; and the vector database corresponds to data summaries for the first tenant.

Aspect 11: The method of any of aspects 1 through 10, wherein the natural language query associated with the data metric comprises a question asking why a change occurred to the data metric in the multi-tenant database system.

Aspect 12: The method of any of aspects 1 through 11, wherein the one or more query response portions indicate one or more changes to other data metrics in the multi-tenant database system that affected the data metric in the multi-tenant database system.

Aspect 13: An apparatus for multi-metric query responses, comprising: one or more memories storing processor-executable code; and one or more processors coupled with the one or more memories and individually or collectively operable to execute the code to cause the apparatus to perform a method of any of aspects 1 through 12.

Aspect 14: An apparatus for multi-metric query responses, comprising at least one means for performing a method of any of aspects 1 through 12.

Aspect 15: A non-transitory computer-readable medium storing code for multi-metric query responses, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for multi-metric query responses, comprising:
receiving, from a user device, a natural language query associated with a data metric of a multi-tenant database system;
inputting, to a large language model (LLM), a first generative prompt based at least in part on the natural language query, the LLM outputting a summary of the natural language query for vector embedding;
receiving, from a vector database associated with the multi-tenant database system, one or more query response portions based at least in part on respective distances between a vector representing the summary of the natural language query and one or more vectors representing the one or more query response portions;
inputting, to the LLM, a second generative prompt associated with expanding a data metric set for the natural language query based at least in part on the data metric, the LLM outputting a first set of additional summaries for the vector embedding, wherein the first set of additional summaries is associated with a first set of additional data metrics of the multi-tenant database system;
receiving, from the vector database, a first set of additional query response portions based at least in part on the first set of additional summaries; and
transmitting, to the user device, a response to the natural language query based at least in part on the one or more query response portions and the first set of additional query response portions.

2. The method of claim 1, further comprising:
inputting, to the LLM, a third generative prompt associated with a recursive expansion of the data metric set for the natural language query based at least in part on the first set of additional data metrics, the LLM outputting a second set of additional summaries for the vector embedding associated with a second set of additional data metrics of the multi-tenant database system; and
receiving, from the vector database, a second set of additional query response portions based at least in part on the second set of additional summaries, wherein the response to the natural language query is further based at least in part on the second set of additional query response portions.

3. The method of claim 2, wherein a quantity of sets of additional summaries for the vector embedding corresponds to a threshold depth for the recursive expansion of the data metric set.

4. The method of claim 3, further comprising:
receiving, from the user device, an indication of the threshold depth for the recursive expansion of the data metric set.

5. The method of claim 3, further comprising:
setting the threshold depth for the recursive expansion of the data metric set to a default value.

6. The method of claim 1, further comprising:
inputting, to the LLM, a third generative prompt associated with broadening from the data metric to the first set of additional data metrics, the LLM outputting a set of non-specific metrics relating to the data metric; and
receiving, from the vector database, the first set of additional data metrics based at least in part on the set of non-specific metrics relating to the data metric, wherein the second generative prompt is based at least in part on the first set of additional data metrics.

7. The method of claim 1, further comprising:
inputting, to the LLM, a third generative prompt based at least in part on the natural language query, the one or more query response portions, and the first set of additional query response portions, wherein the LLM outputs the response to the natural language query.

8. The method of claim 1, further comprising:
retrieving, from the multi-tenant database system, a plurality of data metrics associated with data for a customer relationship management (CRM) system;
inputting, to the LLM, one or more generative prompts based at least in part on the plurality of data metrics, the LLM outputting a plurality of summaries of the data for the CRM system; and
embedding the plurality of summaries as a plurality of vectors in a vector space corresponding to the vector database associated with the multi-tenant database system, wherein the plurality of vectors comprises the one or more vectors representing the one or more query response portions.

9. The method of claim 8, further comprising:
updating the plurality of vectors embedded in the vector space based at least in part on an update to the data for the CRM system.

10. The method of claim 8, wherein:
the data for the CRM system corresponds to a first tenant of a plurality of tenants of the multi-tenant database system; and
the vector database corresponds to data summaries for the first tenant.

11. The method of claim 1, wherein the natural language query associated with the data metric comprises a question asking why a change occurred to the data metric in the multi-tenant database system.

12. The method of claim 1, wherein the one or more query response portions indicate one or more changes to other data metrics in the multi-tenant database system that affected the data metric in the multi-tenant database system.

13. An apparatus for multi-metric query responses, comprising:
one or more memories storing processor-executable code; and
one or more processors coupled with the one or more memories and individually or collectively operable to execute the code to cause the apparatus to:
receive, from a user device, a natural language query associated with a data metric of a multi-tenant database system;
input, to a large language model (LLM), a first generative prompt based at least in part on the natural language query, the LLM outputting a summary of the natural language query for vector embedding;
receive, from a vector database associated with the multi-tenant database system, one or more query response portions based at least in part on respective distances between a vector representing the summary of the natural language query and one or more vectors representing the one or more query response portions;
input, to the LLM, a second generative prompt associated with expanding a data metric set for the natural language query based at least in part on the data metric, the LLM outputting a first set of additional summaries for the vector embedding, wherein the first set of additional summaries is associated with a first set of additional data metrics of the multi-tenant database system;
receive, from the vector database, a first set of additional query response portions based at least in part on the first set of additional summaries; and
transmit, to the user device, a response to the natural language query based at least in part on the one or more query response portions and the first set of additional query response portions.

14. The apparatus of claim 13, wherein the one or more processors are individually or collectively further operable to execute the code to cause the apparatus to:
input, to the LLM, a third generative prompt associated with a recursive expansion of the data metric set for the natural language query based at least in part on the first set of additional data metrics, the LLM outputting a second set of additional summaries for the vector embedding associated with a second set of additional data metrics of the multi-tenant database system; and
receive, from the vector database, a second set of additional query response portions based at least in part on the second set of additional summaries, wherein the response to the natural language query is further based at least in part on the second set of additional query response portions.

15. The apparatus of claim 13, wherein the one or more processors are individually or collectively further operable to execute the code to cause the apparatus to:
input, to the LLM, a third generative prompt associated with broadening from the data metric to the first set of additional data metrics, the LLM outputting a set of non-specific metrics relating to the data metric; and
receive, from the vector database, the first set of additional data metrics based at least in part on the set of non-specific metrics relating to the data metric, wherein the second generative prompt is based at least in part on the first set of additional data metrics.

16. The apparatus of claim 13, wherein the one or more processors are individually or collectively further operable to execute the code to cause the apparatus to:
input, to the LLM, a third generative prompt based at least in part on the natural language query, the one or more query response portions, and the first set of additional query response portions, wherein the LLM outputs the response to the natural language query.

17. The apparatus of claim 13, wherein the one or more processors are individually or collectively further operable to execute the code to cause the apparatus to:
retrieve, from the multi-tenant database system, a plurality of data metrics associated with data for a customer relationship management (CRM) system;
input, to the LLM, one or more generative prompts based at least in part on the plurality of data metrics, the LLM outputting a plurality of summaries of the data for the CRM system; and
embed the plurality of summaries as a plurality of vectors in a vector space corresponding to the vector database associated with the multi-tenant database system, wherein the plurality of vectors comprises the one or more vectors representing the one or more query response portions.

18. The apparatus of claim 17, wherein the one or more processors are individually or collectively further operable to execute the code to cause the apparatus to:
update the plurality of vectors embedded in the vector space based at least in part on an update to the data for the CRM system.

19. A non-transitory computer-readable medium storing code for multi-metric query responses, the code comprising instructions executable by one or more processors to:
receive, from a user device, a natural language query associated with a data metric of a multi-tenant database system;
input, to a large language model (LLM), a first generative prompt based at least in part on the natural language query, the LLM outputting a summary of the natural language query for vector embedding;
receive, from a vector database associated with the multi-tenant database system, one or more query response portions based at least in part on respective distances between a vector representing the summary of the natural language query and one or more vectors representing the one or more query response portions;
input, to the LLM, a second generative prompt associated with expanding a data metric set for the natural language query based at least in part on the data metric, the LLM outputting a first set of additional summaries for the vector embedding, wherein the first set of additional summaries is associated with a first set of additional data metrics of the multi-tenant database system;
receive, from the vector database, a first set of additional query response portions based at least in part on the first set of additional summaries; and
transmit, to the user device, a response to the natural language query based at least in part on the one or more query response portions and the first set of additional query response portions.

20. The non-transitory computer-readable medium of claim 19, wherein the instructions are further executable by the one or more processors to:
input, to the LLM, a third generative prompt associated with a recursive expansion of the data metric set for the natural language query based at least in part on the first set of additional data metrics, the LLM outputting a second set of additional summaries for the vector embedding associated with a second set of additional data metrics of the multi-tenant database system; and
receive, from the vector database, a second set of additional query response portions based at least in part on the second set of additional summaries, wherein the response to the natural language query is further based at least in part on the second set of additional query response portions.
